(19) United States
(12) Patent Application Publication
(10) Pub. No.: US 2025/0013057 A1
(43) Pub. Date: Jan. 9, 2025

(54) Electronic Devices With Adjustable Light-Blocking Structures

(71) Applicant: Apple Inc., Cupertino, CA (US)

(72) Inventors: Paul X. Wang, Cupertino, CA (US); Michael Y. Cheung, Santa Clara, CA (US)

(21) Appl. No.: 18/346,724

(22) Filed: Jul. 3, 2023

(51) Int. Cl. G02B 27/01

(52) U.S. Cl. CPC G02B 27/0176

(57) ABSTRACT

A head-mounted device may have a housing containing displays that display images for a user when the head-mounted device is worn. The head-mounted device may include a nosepiece coupled to the housing and configured to rest on a nasal region of the user. The nosepiece may include an adjustable portion to change a curvature of the nosepiece and conform to the user's nose. The adjustable portion may be formed from a central portion of the nosepiece that can be loosened and tightened with respect to a peripheral portion of the nosepiece, a service loop that extends across the nosepiece, shape memory material that changes shape in response to heat, a deformable stiffener that runs across a nose bridge of the nosepiece, and/or a cavity that can be filled with material to change the curvature of the nosepiece. The nosepiece may be removably coupled to the housing, such as with magnets.

### FIELD

This relates generally to electronic devices, and, more particularly, to electronic devices such as head-mounted devices.

### BACKGROUND

Electronic devices such as head-mounted devices may have one or more displays for displaying images. The displays may be housed in a head-mounted support structure.

### SUMMARY

A head-mounted device may have a main housing unit, at least one display in the main housing unit, and a nosepiece coupled to the main housing unit. The nosepiece may be a light-shielding structure that includes rigid members, flexible members, and/or fabric members. The nosepiece may be removably coupled to the housing, such as with magnets.

The nosepiece may include an adjustable portion to change a curvature of the nosepiece and conform to a user's nose. The adjustable portion may be formed from a central portion of the nosepiece that can be loosened and tightened with respect to a peripheral portion of the nosepiece. For example, the central portion may have tabs that extend through openings in the peripheral portion. The tabs may be tightened and loosened to change the curvature of the nosepiece, and may be friction fit within the openings to maintain the curvature of the nosepiece. The central portion may have slits that allow the central portion to conform to a shape of the user's nose.

Alternatively or additionally, a service loop may extend across the nosepiece and may be loosened or tightened to adjust the nosepiece. The service loop may be loosened and tightened automatically, such as through a spring-loaded mechanism, or may be manually loosened and tightened by the user.

Shape memory material that changes shape in response to heat, such as the user's body heat, may be incorporated into the nosepiece to passively or automatically adjust the shape of the nosepiece. The shape memory material may form the entire nosepiece, or may be incorporated as a deformable stiffener that runs across a nose bridge of the nosepiece.

A cavity may be included in the nosepiece that be filled with material to change the curvature of the nosepiece. The cavity may be filled with air, liquid, and/or solid material, such as foam. The curvature adjustments may occur manually or automatically.

### BRIEF DESCRIPTION OF THE DRAWINGS

FIG. 1 is a diagram of an illustrative electronic device in accordance with some embodiments.

FIG. 2 is a front view of an illustrative electronic device with a light-shielding structure in accordance with some embodiments.

FIG. 3 is a top view of an illustrative nosepiece having an adjustable central portion in accordance with some embodiments.

FIG. 4 is a top view of an illustrative central portion of a nosepiece having slits in accordance with some embodiments.

FIG. 5 is a perspective view of an illustrative nosepiece having an adjustable service loop in accordance with some embodiments.

FIG. 6 is a perspective view of an illustrative nosepiece formed from shape memory material in accordance with some embodiments.

FIG. 7 is a perspective view of an illustrative nosepiece that includes a deformable stiffener in accordance with some embodiments.

FIG. 8 is a front view of an illustrative nosepiece having a cavity that is filled with fluid to adjust the nosepiece in accordance with some embodiments.

FIG. 9 is a front view of an illustrative nosepiece having a cavity that is filled with solid material to adjust the nosepiece in accordance with some embodiments.

FIG. 10 is a front view of an illustrative electronic device with a removably attached nosepiece in accordance with some embodiments.

### DETAILED DESCRIPTION

Head-mounted devices include head-mounted support structures that allow the devices to be worn on the heads of users. The head-mounted support structures may include device housings for housing components such as displays that are used for presenting a user with visual content. The displays may display the visual content to eye boxes, in which the user's eyes may be located when the user wears the head-mounted device.

Head-mounted devices may also include a light-shielding nosepiece that rests on the nose of the user. The light-shielding nosepiece may prevent ambient light from leaking to the eye boxes. To ensure that the light-shielding nosepiece blocks sufficient ambient light, while remaining comfortable for individual users, the light-shielding nosepiece may be adjustable. For example, the nosepiece may have a central portion with extending tabs that can be tightened or loosened to fit a user's nose. In other words, the central portion may be adjusted to adjust a curvature of the nosepiece. The central portion may have slits to allow the central portion to conform to the shape of the user's nose.

Alternatively or additionally, the entire nosepiece may be adjustable, such as by adjusting a service loop that runs through a portion of the nosepiece, heating heat-sensitive material in the nosepiece so that it conforms to the nose, changing the air pressure in the nosepiece, and/or deforming shape-memory material in the nosepiece. Adjusting the nosepiece may change the curvature of the nosepiece to conform the nosepiece to the user's nose. In some embodiments, the nosepiece may be removable from the head-mounted device to provide the user with a better fit.

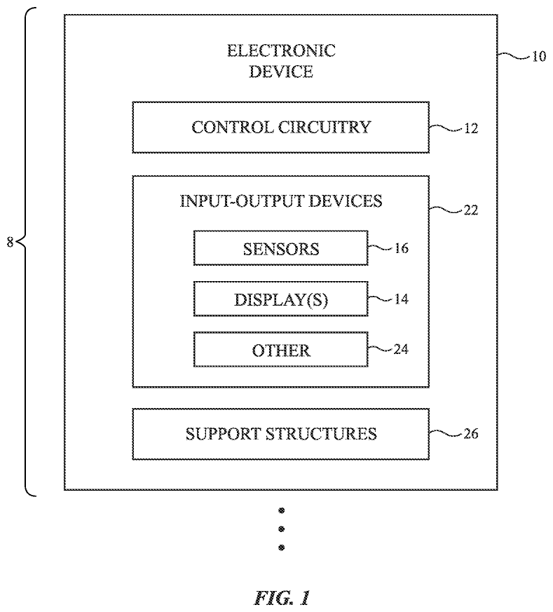

A schematic diagram of an illustrative system having an electronic device that may include an adjustable light-shielding nosepiece is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involved in processing three-dimensional facial image data, operations involving the adjustment of components using control signals, etc.). Control circuitry 12 may include wired and wireless communications circuitry. For example, control circuitry 12 may include radio-frequency transceiver circuitry such as cellular telephone transceiver circuitry, wireless local area network (WiFi®) transceiver circuitry, millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video and/or audio data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as display 14. In some configurations, display 14 of device 10 includes left and right display panels (sometimes referred to as left and right portions of display 14 and/or left and right displays) that are in alignment with eye boxes that include the user's left and right eyes when the device is worn by the user, and are viewable through left and right lens assemblies, respectively. In other configurations, display 14 includes a single display panel that extends across both eyes.

Display 14 may be used to display images. The visual content that is displayed on display 14 may be viewed by a user of device 10. Displays in device 10 such as display 14 may be organic light-emitting diode displays or other displays based on arrays of light-emitting diodes, liquid crystal displays, liquid-crystal-on-silicon displays, projectors or displays based on projecting light beams on a surface directly or indirectly through specialized optics (e.g., digital micromirror devices), electrophoretic displays, plasma displays, electrowetting displays, microLED displays, or any other suitable displays.

Display 14 may present computer-generated content such as virtual reality content and/or mixed reality content to a user. Virtual reality content may be displayed in the absence of real-world content. Mixed reality content, which may sometimes be referred to as augmented reality content, may include computer-generated images that are overlaid on real-world images. The real-world images may be captured by a camera (e.g., a forward-facing camera) and merged with overlaid computer-generated content or an optical coupling system may be used to allow computer-generated content to be overlaid on top of real-world images. As an example, a pair of mixed reality glasses or other augmented reality head-mounted display may include a display device that provides images to a user through a beam splitter, prism, holographic coupler, or other optical coupler. Configurations in which display 14 is used to display virtual reality content to a user through lenses are described herein as an example.

Input-output devices 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, buttons, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), fingerprint sensors and other biometric sensors, optical position sensors (optical encoders), and/or other position sensors such as linear position sensors, and/or other sensors.

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, and other electrical components. Device 10 may include circuits for receiving wireless power, circuits for transmitting power wirelessly to other devices, batteries and other energy storage devices (e.g., capacitors), joysticks, buttons, and/or other components.

Electronic device 10 may have housing structures (e.g., housing walls, straps, etc.), as shown by illustrative support structures 26 of FIG. 1. In configurations in which electronic device 10 is a head-mounted device (e.g., a pair of glasses, goggles, a helmet, a hat, a headband, etc.), support structures 26 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support display(s) 14, sensors 16, other components 24, other input-output devices 22, and control circuitry 12.

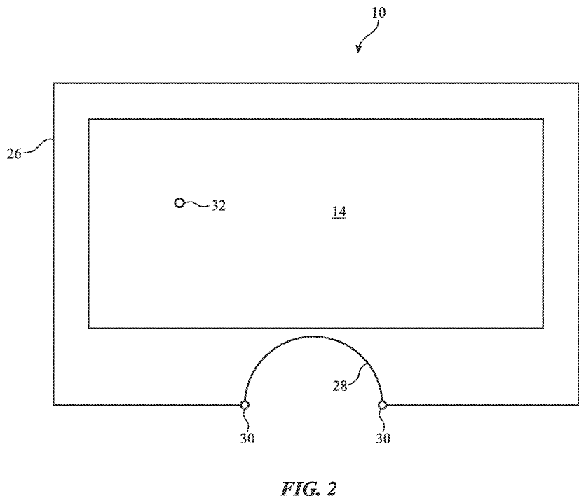

In some embodiments, support structures 26 may include a light-shielding nosepiece. The light-shielding nosepiece may be attached to support structures 26, such as a main housing portion of electronic device 10, and may rest on the user's nose while device 10 is worn. The light-shielding nosepiece may be flexible, to allow the nosepiece to conform to the user's nose, while retaining enough rigidity to support device 10 on the user's face while it is being worn (i.e., to maintain its shape on the user's nose while the device is worn). If desired, the light-shielding nosepiece may also be adjustable to allow the nosepiece to conform to the user's nose. In this way, the light-shielding nosepiece may fit noses of various shapes and sizes. An example of an illustrative electronic device having a nosepiece is shown in FIG. 2.

As shown in FIG. 2, head-mounted device 10 may include support structures 26, which may include a head-mounted housing (sometimes referred to as a main housing, main housing unit, head-mounted support structure, etc.). The housing may have walls or other structures that separate an interior housing region from an exterior region surrounding the housing. For example, the housing may have walls formed from polymer, glass, metal, and/or other materials. Electrical and optical components may be mounted in the housing. These components may include components such as integrated circuits, sensors, control circuitry, input-output devices, etc.

To present a user with images for viewing from eye boxes (e.g., eye boxes in which the user's eyes are located when device 10 is being worn on the user's head), device 10 may include displays and lenses. These components may be mounted in optical modules or other supporting structure in the housing to form respective left and right optical systems. There may be, for example, a left display for presenting an image through a left lens to a user's left eye in a left eye box and a right display for presenting an image through a right lens to a user's right eye in a right eye box.

If desired, the housing may have forward-facing components such as cameras and other sensors on a front side for gathering sensor measurements and other input and may have a soft cushion on an opposing rear side of the housing. The rear side of the housing may have openings that allow the user to view images (e.g., image light 32) from the left and right optical systems (e.g., when the rear side of the housing is resting on the user's head).

If desired, device 10 may have an adjustable strap or headband, and if desired, may have other structures (e.g., an over-the-head strap) to help hold the housing on the user's head.

As shown in FIG. 2, when worn by the user, device 10 may include a nosepiece, such as nosepiece 28 that rests on the nasal region the user's head (e.g., on the user's nose). In particular, nosepiece 28 (sometimes referred to as a light-shielding structure or a light-shielding nosepiece herein) may serve as an extension of the housing that rests on the user's nose and bridges between the opposing cheeks of the user. If desired, nosepiece 28 may be attached to the housing and/or may include one or more members formed from a portion of the housing. In some embodiments, nosepiece 28 may be a portion of a light seal or attached to a light seal that extends around some or all of a periphery of the housing (e.g., the light seal is attached to the housing around the periphery). When device 10 is in use, the light seal may compress against the user's face and prevent interference from ambient light. In general, however, nosepiece 28 may be attached to the housing in any desired manner.

Nosepiece 28 may be configured as a light-shielding structure and may therefore be sometimes referred to as light-shielding structure 28 or light-shielding nosepiece 28. As an example, it may be desirable to enhance the viewing experience of the user by blocking external environmental light from entering the interior of device 10 (e.g., from entering the eye boxes) when device 10 is worn by the user. Nosepiece 28 may conform to the facial topology of the user around the user's nose and block light from entering the eye boxes. In some illustrative configurations, nosepiece 28 may be adjustable to conform to varying facial topologies of different users (e.g., portions of nosepiece 28 may deform differently based on the nose shapes of the users).

Nosepiece 28 may be mounted to a housing portion of electronic device 10, such as head-mounted support structures 26, at mounting points 30. The housing may include a housing frame that runs along the periphery of device 10. If desired, the housing frame may be overlapped by a cushion member on the rear side of the housing facing the user. As an example, the cushion member may include foam structures or other soft compressible structures affixed to the housing frame. A fabric may overlap and extend over the housing frame and/or the cushion member on the rear side of the housing. If desired, the fabric may enclose only the cushion member, and the fabric-enclosed cushion member may be removably coupled to the housing frame.

Mounting points 30 may be located at a bottom portion of the housing frame (e.g., a bottom portion of support structures 26). As examples, mounting points 30 may include coupling mechanisms such as magnets, adhesive, hinges, or any other suitable coupling mechanisms.

In the example of FIG. 2, nosepiece 28 is attached to support structures 26 such that nosepiece 28 extends into a portion of support structures 26. This is merely illustrative. If desired, the housing frame, a cushion member, and/or fabric may split into multiple portions to surround nosepiece 28. As an example, a fabric-enclosed cushion member may run in front of nosepiece 28, and a housing frame may run behind nosepiece 28. In general, the housing portions, cushion member, and/or fabric may define an opening in which nosepiece 28 is disposed.

In some illustrative examples, nosepiece 28 may be removably coupled (via magnetics) to the housing frame or other portions of the housing. In some illustrative examples, a portion of nosepiece 28 may form an integral portion of the housing frame and/or may not be removable from the housing.

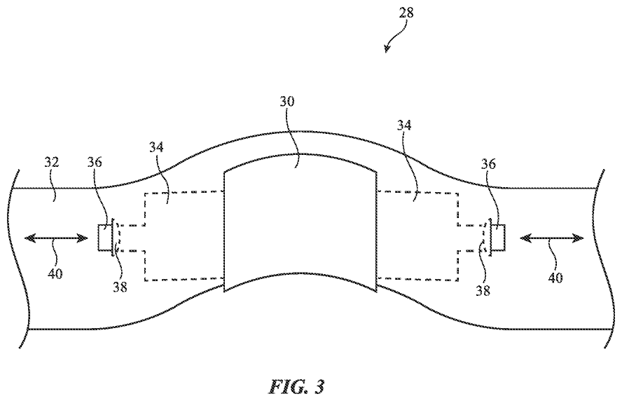

Support structures 26 (e.g., housing frames) and nosepiece 28 (along with other desired structures) may define the periphery of the eye boxes of device 10 at which the user's eyes are located. Components, such as displays, lenses, sensors, etc., may overlap and/or be located within the eye boxes of device 10, and may be enclosed by and/or mounted to support structures 26 and/or nosepiece 28. As illustratively shown in FIG. 2, display 14 emit image light 32 through a lens to an eye box. Nosepiece 28 may be configured to block environmental light from an exterior of device 10 from entering the eye box and interfering with image light 24. In some embodiments, it may be desirable for nosepiece 28 to be adjustable to conform to a user's nose. An example of an adjustable nosepiece that may be used in device 10 is shown in FIG. 3.

As shown in FIG. 3, an adjustable nosepiece, such as nosepiece 28 may include adjustable central portion 30. Adjustable central portion 30 may be formed from elastomeric material, such as thermoplastic polyurethane (TPU), nitrile butadiene rubber (NBR), or silicone, or may be formed from another flexible or semi-flexible material.

Adjustable central portion 30 may be coupled to peripheral portion 32. In particular, adjustable central portion 30 may be on the exterior of peripheral portion 32 (e.g., opposite the user's nose/face when the device is worn by a user) and may have internal portions 34 that pass into peripheral portion 32. For example, peripheral portion 32 may be formed from two or more layers of material, and internal portions 34 may pass through some of the layers; peripheral portion 32 may have cavities, and internal portions 34 may pass through the cavities; or adjustable central portion 30 may be formed on an outer surface of peripheral portion 32 (e.g., opposite the user's nose when the device is worn by the user), and internal portions 34 may be formed on an opposing inner surface of peripheral portion 32 (e.g., in contact with the user's nose/face).

Peripheral portion 32 may be a dedicated portion of nosepiece 28. For example, peripheral portion 32 may be attached to support structures 26 via mounted points 30 (FIG. 2). Alternatively, peripheral portion 32 may be a portion of support structures 26, such as a portion of a light seal, fabric curtain, or other portion of support structures 26. In general, peripheral portion 32 may be any suitable portion of nosepiece 28 and/or support structures 26, and adjustable central portion 30 may be coupled to peripheral portion 32.

Regardless of how central portion 30 is incorporated into and attached to peripheral portion 32, central portion 30 may have tabs 36 that pass through openings 38 of peripheral portion 32. Tabs 36 may be at the exterior of peripheral portion 32.

To adjust central portion 30 against the user's nose, tabs 36 may be pulled or pushed along directions 40. In particular, by pulling tabs 36 away from each other, central portion 30 may have a flatter profile. In contrast, by pushing tabs 36 toward one another, central portion 30 may have a sharper profile. Tabs 36 may be friction fit within openings 38 to maintain the profile of central portion 30 after tabs 36 are adjusted. In this way, tabs 36 may be adjusted to adjust central portion 30 and change the curvature of nosepiece 28, thereby allowing nosepiece 28 to conform to the user's nose.

Although FIG. 3, shows tabs 36 that can be manually pulled and pushed in directions 40 by a user of a head-mounted device (or by another person assisting the user of the head-mounted device), this is merely illustrative. In some embodiments, nosepiece 28 may include a dial that is attached to one or both of internal portions 34. Twisting the dial may tighten/loosen nosepiece 28. Moreover, while tabs 36 are shown at the exterior of nosepiece 28, tabs 36 may be formed on the inside of nosepiece 28 (e.g., in contact with the user's nose/face when the device is worn by the user), if desired.

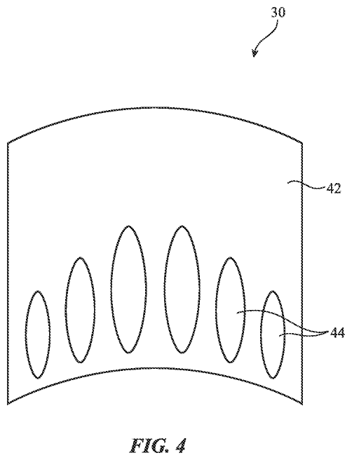

To allow central portion 30 to bend when tabs 36 are adjusted (or central portion 30 is otherwise adjusted to conform to a user's nose), slits may be formed in central portion 30. An illustrative example of a portion of a nosepiece having slits is shown in FIG. 4.

As shown in FIG. 4, central portion 30 may include flexible or semi-flexible material 42. For example, material 42 may be formed from elastomeric material, such as thermoplastic polyurethane (TPU), nitrile butadiene rubber (NBR), or silicone, or may be formed from another flexible or semi-flexible material.

Slits 44 may be formed in material 42. For example, slits 44 may be formed through laser ablation, cutting, or otherwise forming slits 44. Slits 44 may extend completely through material 42, as shown in FIG. 4. Alternatively slits 44 may extend partially through material 42. Moreover, slits 42 may have any suitable width. In an illustrative embodiment, slits 42 may have a near-zero width when central portion 30 is not stretched over a nose (e.g., slits 42 may be closed), and may have visible width when central portion 30 is stretched over the nose (e.g., as shown in FIG. 4). In this way, slits 44 may allow material 42 to conform to the curvature of a user's nose.

Although FIG. 4 shows slits 44 only in central portion 30, slits 44 may extend over any suitable portion of nosepiece 28, such as peripheral portions 34 (FIG. 3).

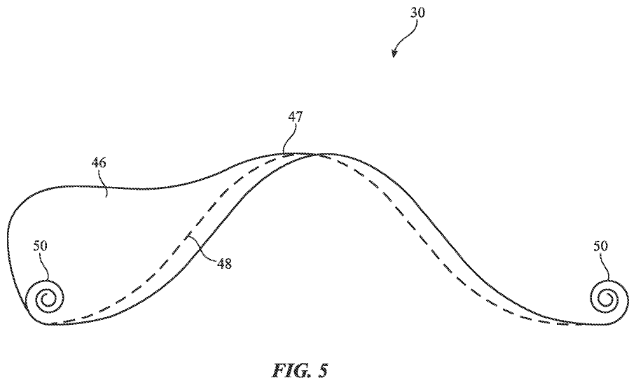

In FIGS. 3 and 4, central portion 30 is used to adjust nosepiece 28 to conform to a user's nose. In the example of FIG. 3, central portion 30 may be tightened and loosened. However, this is merely illustrative. If desired, an entirety of nosepiece 28 may be adjusted to conform to a user's nose. An illustrative example of a nosepiece that may be adjusted to a user's nose is shown in FIG. 5.

As shown in FIG. 5, nosepiece 28 may include material 46. Nosepiece 28 may also have nose bridge 47, which may sit on a user's nose when a head-mounted device is worn by the user. Material 46 may be formed from elastomeric material, such as thermoplastic polyurethane (TPU), nitrile butadiene rubber (NBR), or silicone, or may be formed from another flexible or semi-flexible material.

Nosepiece 28 may include service loop 48 that extends between end portions 50. Service loop 48 may be formed from a strip or length of metal, polymer, or other suitable material. A user of a head-mounted device (or another person assisting the user) may tighten or loosen service loop 48 by adjusting end portions 50. For example, service loop 48 may be wound up at portions 50 to tighten service loop 48 against the user's nose. Alternatively, a portion of service loop 48 may be released from portions 50 to loosen service loop 48. In this way, the tightness of service loop 48, and therefore the tightness of nose bridge 47, may be adjusted, allowing the curvature of nosepiece 28 to change and nosepiece 28 to conform to the user's nose.

Although not shown in FIG. 5, end portions 50 of service loop 48 may be spring loaded. In other words, end portions 50 may wrap around a spring-loaded structure. The spring-loaded structure may pull service loop 48 against the user's nose, thereby automatically conforming nosepiece 28 against the user's nose.

In the example of FIG. 5, service loop 48 has symmetrical end portions 50 on either side of nosepiece 28. However, this is merely illustrative. Service loop 48 may have an asymmetric end portion 50, if desired. In other words, service loop 48 may wrap up around an end portion 50 at a single side of nosepiece 28. Additionally, service loop 48 may extend entirely across nosepiece 28, as in the example of FIG. 5, or service loop 48 may extend only partially across nosepiece 28, such as across half of nosepiece 28. This arrangement may accommodate nose asymmetry or the presence of asymmetry in the nasal region, such as piercings.

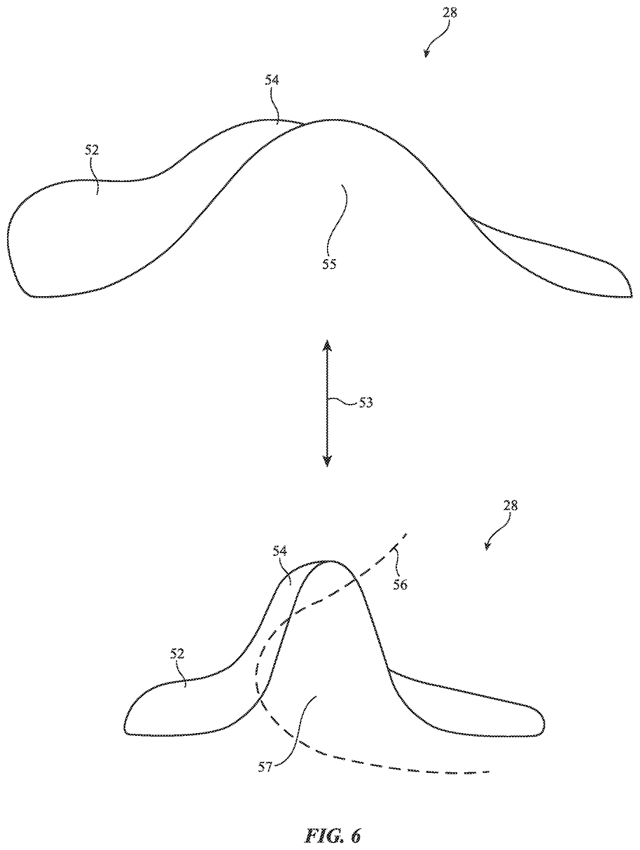

Although the example of FIG. 5 shows using service loop 48 to tighten and loosen nosepiece 28 against a user's nose, this is merely illustrative. In some embodiments, nosepiece 28 may conform to a user's nose using heat. An illustrative example is shown in FIG. 6

As shown in FIG. 6, nosepiece 28 may be formed from material 52. Material 52 may include a shape memory polymer, a shape memory alloy, heat-sensitive material, and/or other suitable material. Nosepiece 28 may have nose bridge 54 that rests on a user's nose when the user wears a head-mounted device.

As indicated by arrow 53, when the user inserts nose 56 into nose bridge 54, material 52 can conform to the shape of nose 56. In particular, because material 52 is formed from shape memory material, the heat from nose 56 may activate material 52 and cause material 56 to collapse inward toward nose 56. In this way, nosepiece 28 may conform to user's nose 56 when nosepiece 28 is worn by the user.

In some embodiments, material 52 may be a shape memory material that has two or three different memory shapes. For example, when no additional heat is applied to material 52 (e.g., when material 52 is at room temperature or below a threshold temperature), material 52 may have shape 55. However, when heat is applied to material 52 (e.g., when nosepiece 28 is worn and body heat is applied to material 52), material 52 may have shape 57, which may correspond with the shape of nose 56. Nosepiece 28 may change between shape 55 and shape 57 (e.g., may change curvature) as the nosepiece is donned and removed from the user's nose 56, as indicated by arrow 53.

However, this is merely illustrative. In some embodiments, nosepiece 28 may be formed from a material 52 that is activated by heat a single time. For example, material 52 may be a shape memory polymer or alloy that is heated into a desired shape (e.g., the shape of the user's nose) based on a three-dimensional scan of the nose, a single time around the user's nose, or otherwise heated into the desired shape. For example, resistive heating elements or other heating elements may be used to heat material 52 into the desired shape. Material 52 may then take the desired shape when worn by the user (e.g., in response to the user's body heat), and return to the original shape when not worn.

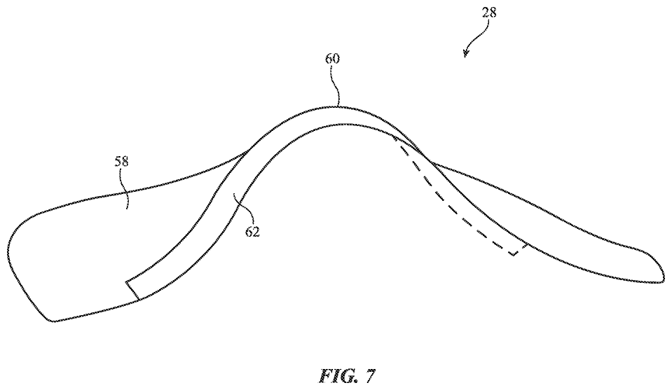

Instead of, or in addition to, adjusting the shape of a nosepiece using heat, the nosepiece may include a deformable stiffener that can be used to conform to the user's nose. An illustrative example of a nosepiece with a deformable stiffener is shown in FIG. 7.

As shown in FIG. 7, nosepiece 28 may include material 58, which may be formed from elastomeric material, such as thermoplastic polyurethane (TPU), nitrile butadiene rubber (NBR), or silicone; shape memory material, such as shape memory alloy or polymer; or another flexible or semi-flexible material. Nosepiece 28 may also include nose bridge 60 that may rest on a nose of a user when a head-mounted device is worn by the user.

Nosepiece 28 may include deformable stiffener 62 that extends across nose bridge 60. Deformable stiffener 62 may be formed from metal, such as a thin layer of steel, aluminum, or other metal, polymer, or other deformable material. When nosepiece 28 is worn by a user, the user may press nosepiece 28 onto their nose, thereby changing the curvature of nosepiece 28, and deformable stiffener 62 may take the shape of the user's nose. In this way, nosepiece 28 may conform to the user's nose.

In some embodiments, deformable stiffener 62 may be formed from a shape memory material, such as a shape memory metal or polymer. Deformable stiffener 62 may change from having a first shape, such as the shape shown in FIG. 7, to a shape that corresponds to the shape of a user's nose, in response to a stimulus, such as the user's body heat. In other words, deformable stiffener 62 may have a wider shape at room temperature (or other temperature below a suitable threshold), and a shape that conforms to the nose at a higher temperature (such as body temperature or a temperature otherwise over the threshold). By forming deformable stiffener 62 from shape memory material, nosepiece 28 may change curvature and conform to the user's nose without external force applied to deformable stiffener 62.

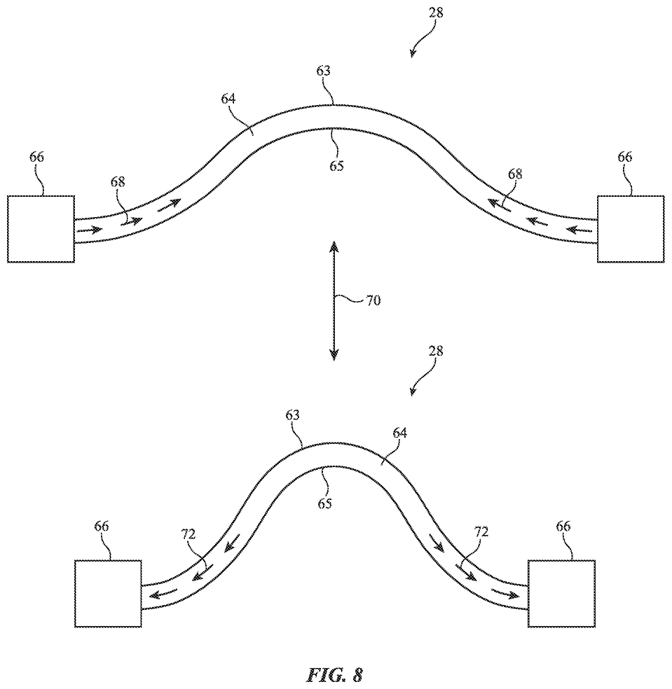

In other embodiments, air pressure may be used to adjust nosepiece 28 to allow nosepiece 28 to conform to a user's nose. An illustrative example of a nosepiece that is adjustable with air pressure is shown in FIG. 8.

As shown in FIG. 8, nosepiece 28 may be include hollow cavity 64. For example, nosepiece 28 may be formed from two layers of material 63 and 65, with intervening cavity 64. Alternatively, nosepiece 28 may be formed from a single layer of material that has cavity 64 (e.g., a tube-like layer of material with cavity 64).

To increase the curvature of nosepiece 28, pumps 66 may pump air into cavity 64, as shown by arrows 68. Pumps 66 may be any suitable air pumps that are capable of pumping air into cavity 64.

By pumping air into cavity 64, nosepiece 28 may have an increased curvature, as shown by lower nosepiece 28 (e.g., on the opposite side of arrow 70). If pumps 66 are activated while the user is wearing nosepiece 28, the increased curvature may conform to the user's nose. To return nosepiece 28 to its original shape and curvature, pumps 66 may pump air out of cavity 64, as shown by arrows 72. Nosepiece 28 may then return to its original shape and curvature, as shown by top nosepiece 28 (e.g., on the opposite side of arrow 70). In this way, pumps 66 may be used to adjust the curvature of nosepiece 28 to fit noses of different shapes and sizes.

Although pumps 66 have been described as pumping air into cavity 64, this is merely illustrative. If desired, liquid (e.g., liquid from a reservoir in the head-mounted device) may be used to fill cavity 64. In other words, pumps 66 may be hydraulic pumps, if desired. In general, any fluid may be used to fill cavity 64.

In some embodiments, pumps 66 may be omitted. For example, when a user dons the head-mounted device, a cushion member may press against the user's face and expel air. This air may be channeled to nosepiece 28 to fill cavity 64 so that nosepiece 28 can conform to the user's nose.

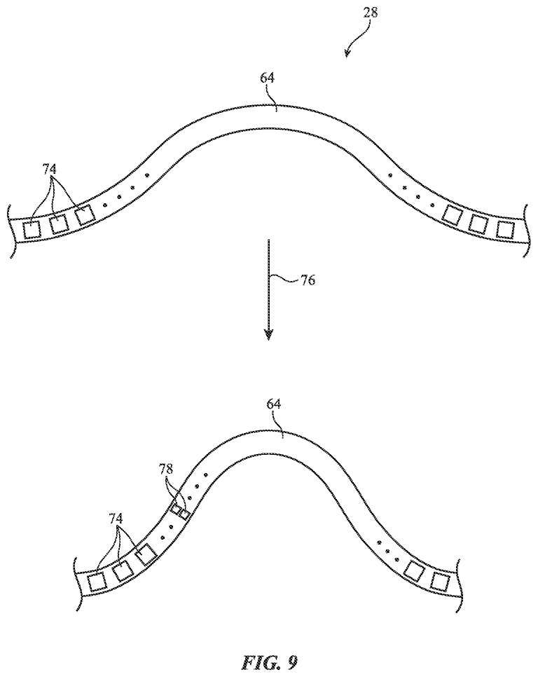

The use of air or liquid to fill cavity 64 is merely illustrative. If desired, solid object may fill nosepiece 28, and nosepiece 28 may be adjusted by increasing or decreasing the volume of solid objects within nosepiece 28. An illustrative example of solid objects used to fill a nosepiece is shown in FIG. 9.

As shown in FIG. 9, nosepiece 28 may include filler material 74 in cavity 64. Filler material 74 may be a foam material, such as polyurethane foam, or other suitable material. In some embodiments, it may be desirable to use a material that is flexible enough to conform to the user's nose, while remaining rigid enough for nosepiece 28 to maintain its shape when removed from the user's nose.

As indicated by arrow 76, additional filler material 78 may be added in cavity 64. Additional filler material 78 may be wider than filler material 74, and thereby selectively widen portions of nosepiece 28, as in the illustrative example of FIG. 9. Alternatively, additional filler material 78 may have the same width as filler material 74, and may serve to only change the curvature or tightness of nosepiece 28 against the user's nose. In general, the additional filler material 78 may be added, or additional filler material 78 and/or filler material 74, may be removed to change the shape of nosepiece 28. In this way, the shape of nosepiece 28 may be adjusted, and nosepiece 28 may conform to the user's nose.

In the examples of FIGS. 3-9, nosepiece 28 has been described as including a variety of flexible material. In general, however, these materials are illustrative, and nosepiece 28 may include any suitable materials. For example, nosepiece 28 may be formed from fabric, such as being formed from a fabric-covered shape memory material (or other fabric-covered material). By covering material in nosepiece 28 with fabric, nosepiece 28 may be more comfortable for a user. In other embodiments, nosepiece 28 may be formed entirely from fabric, with reinforcing structures, such as deformable stiffener 62 (FIG. 7) or service loop 48 (FIG. 5). In general, nosepiece 28 may be formed from any material that allows nosepiece 28 to conform to the user's nose, while at least partially maintaining its shape when removed from the user's nose.

Additionally, in the examples of FIGS. 3-9, manual adjustments (e.g., user adjustments) and automatic adjustments (e.g., shape memory alloy shape changing) are described to conform nosepiece 28 to the user's nose. If desired, device 10 may make recommendations to a user to adjust the fitment of nosepiece 28. For example, cameras, ambient light sensors, or other optical sensors in device 10 (e.g., between the user's face and the displays in device 10), may measure an amount of ambient light that reaches the eye boxes. If the amount of ambient light leakage is too high, device 10 may recommend that the user adjust nosepiece 28, such as by tightening central portion 30 (FIG. 3), tightening service loop 48 (FIG. 5), tightening deformable stiffener 62 (FIG. 7), adding fill material (FIG. 9), or otherwise adjusting nosepiece 28. Optionally, device 10 may include automatic adjustment circuitry, such as positioners (e.g., motors), to adjust nosepiece 28, such as by tightening or loosening portions of nosepiece 28 against the user's nose. In this way, nosepiece 28 may conform to the user's nose and provide an improved seal to prevent light from leaking into the eye boxes.

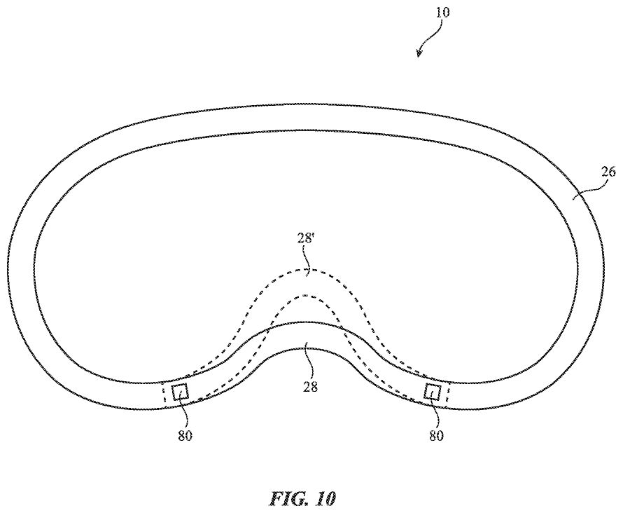

Regardless of the one or more adjustable mechanisms that are incorporated into nosepiece 28, it may be desirable for nosepiece 28 to be removably attached to a head-mounted device. An illustrative example of a nosepiece that may be removably attached to a head-mounted device is shown in FIG. 10.

As shown in FIG. 10, head-mounted device 10 may include nosepiece 28 that is coupled to support structures 26 using attachments 80. Attachments 80 may be, as examples, magnets, clasps, snaps, or other removable coupling mechanisms. Nosepiece 28 may therefore be removed from and attached to support structures 26 as desired, such as to clean or replace nosepiece 28.

Although attachments 80 may be magnets at the ends of nosepiece 28, as shown in FIG. 10, this is merely illustrative. If desired, nosepiece 10 may be covered in fabric, and may include magnetic strands in the fabric (e.g., some of the strands that form the nosepiece fabric may be magnetic). The magnetic strands in the nosepiece may then be magnetically coupled to magnets in support structure 26, thereby removably attaching nosepiece 28 to device 10.

In some embodiments, nosepiece 28 may be a size that corresponds to a user's nose. For example, as shown by nosepiece 28′, a user may remove nosepiece 28 and replace nosepiece 28 with nosepiece 28′. Nosepiece 28′ may be larger to accommodate a larger nose. However, this is merely illustrative. In general, nosepiece 28′ may be smaller than nosepiece 28, or may have other characteristics from nosepiece 28, such as being more flexible or adjustable via other mechanisms.

Nosepieces 28 and 28′ may each be adjustable with one or more of the adjustable features described in connection with FIGS. 3-9. In this way, a user of device 10 may attach a nosepiece to support structures 26, and the nosepiece may conform to the user's nose when the user wears device 10.

The foregoing is merely illustrative and various modifications can be made to the described embodiments. The foregoing embodiments may be implemented individually or in any combination.

1. A head-mounted device, comprising:
a housing;
a display in the housing; and
a nosepiece coupled to the housing, wherein the nosepiece comprises an adjustable portion that is configured to adjust a curvature of the nosepiece, the adjustable portion comprises an adjustable service loop that extends across the nosepiece, and the adjustable service loop comprises opposing first and second ends that are configured to be wound and unwound to tighten and loosen the nosepiece.

2. The head-mounted device of claim 1, wherein the adjustable portion comprises a central portion of the nosepiece that is coupled to a peripheral portion of the nosepiece.

3. The head-mounted device of claim 2, wherein the central portion comprises tabs that extend through openings in the peripheral portion, and the tabs are configured to be adjusted to adjust the curvature of the nosepiece.

4. The head-mounted device of claim 3, wherein the central portion comprises a plurality of slits.

5. (canceled)

6. The head-mounted device of claim 1, wherein the adjustable service loop is configured to be tightened and loosened to adjust the curvature of the nosepiece.

7. The head-mounted device of claim 6, wherein the adjustable service loop is spring-loaded to automatically adjust the curvature of the nosepiece.

8. The head-mounted device of claim 1, wherein the adjustable portion further comprises shape memory material, and the curvature of the nosepiece is configured to change in response to heat on the shape memory material.

9. The head-mounted device of claim 8, wherein the shape memory material is configured to be adjusted between a first shape when a temperature of the shape memory material is below a threshold temperature and a second shape when the temperature of the shape memory material is above the threshold temperature.

10. The head-mounted device of claim 1, wherein the adjustable portion further comprises a deformable stiffener.

11. The head-mounted device of claim 10, wherein the deformable stiffener comprises a metal material.

12. The head-mounted device of claim 10, wherein the deformable stiffener comprises a shape memory alloy or shape memory polymer.

13. The head-mounted device of claim 1, wherein the adjustable portion further comprises a cavity in the nosepiece.

14. The head-mounted device of claim 13, wherein the cavity is configured to be filled with air to change the curvature of the nosepiece.

15. The head-mounted device of claim 14, further comprising a pump that is configured to inflate and deflate the cavity to change the curvature of the nosepiece.

16. The head-mounted device of claim 13, wherein the cavity is configured to be filled with foam to change the curvature of the nosepiece.

17. The head-mounted device of claim 1, wherein the nosepiece is configured to be magnetically attached to the housing.

18. A head-mounted device, comprising:
a housing;
a display in the housing; and
a light-shielding structure coupled to the housing, wherein the light-shielding structure comprises a central portion and a peripheral portion, the central portion comprises solid filler material that is configured to be selectively removed to adjust a curvature of the light-shielding structure.

19. The head-mounted device of claim 18, wherein the central portion comprises slits.

20. The head-mounted device of claim 18, wherein the central portion and the peripheral portion form a nosepiece.

21. The head-mounted device of claim 18, wherein the central portion is a nosepiece and the peripheral portion is part of a light seal that extends around a periphery of the housing.

22. A head-mounted device, comprising:
a housing;
a display in the housing; and
a light-shielding nosepiece comprising shape memory polymer, wherein the shape memory polymer is configured to have a first shape below a temperature threshold and a second shape above the temperature threshold.

23. (canceled)

24. The head-mounted device of claim 22, wherein the entire light-shielding nosepiece is formed from the shape memory polymer.

25. The head-mounted device of claim 22, wherein the shape memory polymer forms a deformable stiffener in the light-shielding nosepiece, and the deformable stiffener runs across a nose bridge of the light-shielding nosepiece.
